(19) United States
(12) Patent Application Publication
(10) Pub. No.: US 2005/0112318 A1
(43) Pub. Date: May 26, 2005

(54) Nanoparticles in optical devices

(76) Inventors: Timothy M. Hsieh, Potomac, MD (US); Jonathan A. Hack, Gainesville, FL (US)

Correspondence Address: Timothy M. Hsieh, 9322 Glen Road, Potomac, MD, 20854, US

(21) Appl. No.: 10/716,469

(22) Filed: Nov. 20, 2003

(51) Int. Cl. G11B 7/24

(52) U.S. Cl. 428/64.4; 351/159

(57) ABSTRACT

An optical recording medium including a substrate that includes a substrate material having a refractive index and a plurality of nanoparticles of a material having a refractive index greater than that of the substrate material. The nanoparticles are included in the substrate material at such a density that the refractive index of the substrate is greater than that of the substrate material without decreasing the transparency of the substrate. The optical recording medium also includes a recording layer, which may further include encoded information, and a protective layer.

### DESCRIPTION OF THE INVENTION

1. Field of the Invention

The subject matter of this application relates to controlling the properties of a material through the use of nanoparticles. In particular, the subject matter of this application relates to controlling the properties of materials used to make optical and ocular devices.

2. Background of the Invention

Two physical properties of the materials that make up optical devices, such as optical recording media, compact discs (CDs), digital video discs (DVDs), and ocular devices are of particular interest: refractive index and the degree to which the material is resistant to being scratched. The refractive index of the material is a factor that determines how much information can be stored on an optical recording media. For example, a material's refractive index controls the degree that light is focused as it passes through material. In a CD, the substrate material focuses light onto an information containing layer. Currently, however, there is no efficient way to adjust the index of refraction of a material without significantly affecting the optical transparency of the material. Thus, the amount of information that can be stored on an optical device is limited by the inability to adjust the refractive index of the substrate material.

Further, materials that make up optical recording media and ocular devices are prone to being scratched. Scratches in the optical recording media affect the record and playback capability of optical recording media. Like the problem of controlling refractive index, there is no efficient way to enhance the scratch resistance of a material without significantly affecting the optical transparency of the material.

Thus, what is needed is the ability to adjust the refractive index and/or the scratch resistance of a material without significantly affecting the optical transparency of the material

### SUMMARY OF THE INVENTION

In accordance with an embodiment of the present invention, there is an optical recording medium comprising a substrate including a substrate material having a refractive index and a plurality of nanoparticles of a material having a refractive index greater than that of the substrate material. The nanoparticles are included in the substrate material at such a density that the refractive index of the substrate is greater than that of the substrate material without decreasing the transparency of the substrate. The optical recording medium also includes a recording layer and a protective layer.

In an embodiment of the present invention, the recording layer includes encoded information. Further, the encoded information can be stored as a series of pits in or on the recording layer.

In another embodiment of the present invention, there is an optical recording medium comprising a substrate, a recording layer, and a protective layer. The protective layer includes a protective material having a scratch resistance and a plurality of nanoparticles of a material having a scratch resistance greater than that of the protective material and being included in the protective material at such a density that the scratch resistance of the protective layer is greater than that of the protective material.

In another embodiment of the present invention, there is an ocular device with a scratch resistant surface comprising a transparent matrix material having a surface, and nanoparticles dispersed with the matrix material to provide scratch resistance to the surface of the matrix material.

In another embodiment of the present invention, there is a method of storing data including providing an optical storage medium comprising a substrate, a recording layer, and a protective layer. A light source is used to record information onto the recording layer. The substrate comprises a substrate material having a refractive index and a plurality of nanoparticles having a refractive index greater than that of the substrate material and being included in the substrate material at such a density that the refractive index of the substrate is greater than that of the substrate material without decreasing the transparency of the substrate.

In another embodiment of the present invention, there is an ocular device comprising a matrix material and nanoparticles dispersed within the matrix material to provide scratch resistance to the surface of the matrix material.

In another embodiment of the present invention, there is a method for coating an ocular device in which a transparent matrix material is provided, nanoparticles are dispersed within the matrix material; and the matrix material with the dispersed nanoparticles is applied therein on a surface of the ocular device.

In another embodiment of the present invention, there is an ocular device having a first transparent matrix material and a coating comprising a second transparent matrix material and a plurality of nanoparticles.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a diagrammatic representation of a cross-section of a portion of an optical recording media in accordance with an embodiment of the present invention.

FIG. 2 is a diagrammatic representation of a cross-section of a portion of an optical recording media having information encoded on a recording layer in accordance with an embodiment of the present invention.

FIG. 3A is a diagrammatic representation of a cross-section of an exemplary section of a host material including a plurality of nanoparticles in accordance with an embodiment of the present invention.

FIG. 3B is a diagrammatic representation of a cross-section of an exemplary section of a host material including a plurality of coated nanoparticles in accordance with an embodiment of the present invention.

FIG. 4 is a diagrammatic representation of a cross-section of a portion of a lens of an ocular device including nanoparticles in accordance with an embodiment of the present invention.

FIG. 5 is a diagrammatic representation of a cross-section of a portion of a lens of an ocular device including coated nanoparticles in accordance with an embodiment of the present invention.

FIG. 6 is a diagrammatic representation of a lens of an ocular device including a coating having nanoparticles in accordance with an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

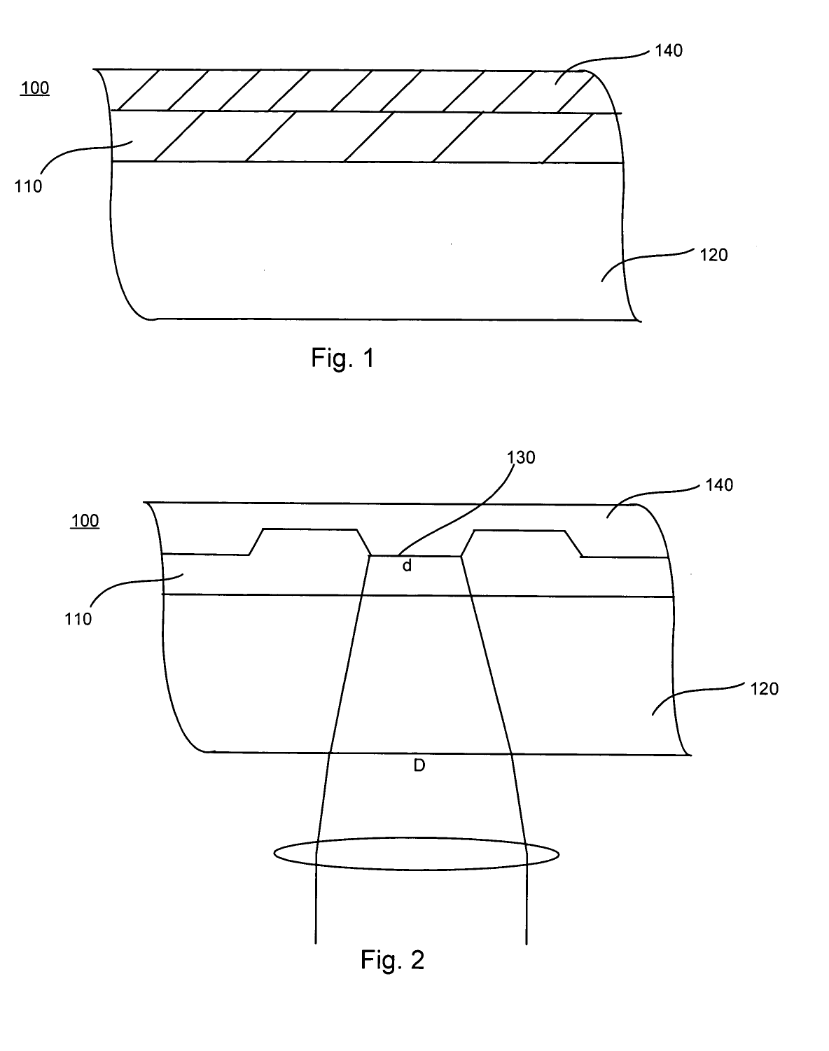

FIG. 1 shows an optical recording media 100 according to an embodiment of the present invention. Optical recording media 100 includes a recording layer 110. A first surface of the recording media 100 is disposed on a substrate 120. The recording layer 110 includes a plurality of pits. Information is typically recorded on the recording layer a series of pits. An exemplary pit 130 is depicted in FIG. 2. Typical information encoded on the recording layer includes audio, video, and/or text data. A protective layer 140 is disposed on a second surface of the recording layer 110.

Information is recorded on the recording layer 110 in such a manner that information is converted into signals corresponding to information pits 130. Each pit 130 has a predetermined size and shape depending on the recorded information. To reproduce the information recorded on optical recording media 100, a light source, such as a laser or light emitting diode (LED) is irradiated and focused onto the substrate 120 in the form of a beam spot having a diameter D, as shown in FIG. 2. Due to the refractive index of the substrate material the original spot incident on the substrate is focused to a spot size d, as shown in FIG. 2, where d is less than D. The substrate causes the light to converge onto the recording layer 110.

Light impinging the recording layer 110 is diffracted and reflected from the information pits 130 and detected by a detector (not shown), such as a photo-diode. The detected light is then converted into an electrical signal.

As will be understood, the information recording density of the optical disc (the amount of information that can be stored on the optical disc) is dependent on two variables. The first variable is the track pitch that includes an interval between the central lines of pit arrays on which information pits are formed. The second variable that affects information recording density is the diameter of the beam spot on the pits. Thus, decreasing the diameter of the beam spot on the pits increases the information recording density of the optical disc.

In an embodiment, substrate 120 comprises a substrate material such as plastic or glass. In certain embodiments the substrate 120 comprises polycarbonate, polymethylmethacrylate (PMMA), or epoxy. As will be known to one of ordinary skill in the art, these substrate materials typically have a refractive index of about 1.55. Similarly, in an embodiment, protective layer 140 comprises glass or plastic, such as polycarbonate, polymethylmethacrylate (PMMA), or epoxy.

In certain embodiments, substrate 120 includes a plurality of nanoparticles. The nanoparticles have a refractive index different than that of the substrate material. Including nanoparticles into the substrate alters the refractive index of the substrate 120 without substantially reducing the transparency of the substrate 120. Including nanoparticles into the substrate increases the refractive index of the substrate.

With a refractive index of 1.55, typical optical devices are capable of focusing the spot size of a laser impinging the surface of the substrate to about 1.7 μm. However, with the inclusion of nanoparticles into the substrate the refractive index of the substrate to be adjusted to be greater than 1.55. This allows the spot size to be focused smaller than 1.7 μm.

In general, the nanoparticles used in the embodiments described herein can be produced using a variety of materials. For example, the materials used to make the nanoparicles can be single elements, such as the Group IV elements, metals or the rare earth elements. Alternatively, the materials can be nitrides, oxides, phosphides, carbides, sulfides, or selenides, or combinations thereof. In certain embodiments, the materials can be metal oxides including titanium dioxide (TiO₂), magnesium oxide (MgO), yttria (YtO), zircronia (ZrO₂), CeOₓ, alumina (Al₂O₃), lead oxide (PbOₓ), or composites of these oxides. In other embodiments, the materials can be made from III-V compounds or II-VI compounds. The materials can also include zinc selenide (ZnSe), zinc sulfide (ZnS), and alloys made from Zn, Se, S, Si, Fe, C, B, BN, and Te. Further, the materials can be gallium nitride (GaN), AlGaN, silicon nitride (Si₃N₄), SiN, or aluminum nitride. The material of the nanoparticles can also be metallic elements, such as, for example, Ag, Al, Au, Co, Cu, Fe, Mo, Ni, and W. The material of the nanoparticles can also be non-metallic elements such as, for example, Si and C, in any of its various forms (diamond, graphite, nanofibers, single and multi-walled nanotubes). These materials may be used individually or combined to form nanoparticles.

The nanoparticles used in the embodiments described herein may be substantially spherical. Alternatively, the shape of the nanoparticles may be non-spherical. For example, the shape of the nanoparticles may be faceted or may assume geometrical shapes such as cubes, pyramids, triangles, trapezoids, parallelograms, hexagons, tubes, or other shapes. However, the nanoparicles do not need to have the same shape.

The nanoparticles used in the embodiments described herein may be of various sizes. For example, the average size of the nanoparticles may be less than about each of the following: 1,000 nm, 700 nm, 500 nm, 100 nm, 75 nm, 50 nm, 25 nm, 15 nm, 10 nm, 5 nm, 2 nm, or 1 nm. In embodiments where the nanoparticles are used in optical recording media the nanoparticles may be ⅕ of the wavelength of the emitted light. Alternatively, the size of the nanoparticles may be in the range of 1/10 to 1/20 of the wavelength of the emitted light. In embodiments where the nanoparticles are used in ocular devices the nanoparticles may be ⅕ of the wavelength of UV light, visible light, or IR light. Alternatively, in these embodiments, the nanoparticles may be in the range of 1/10 to 1/20 of the wavelength of UV light, visible light, or IR light.

In certain embodiments, nanoparticles are included into the materials making up the devices at a wt % of less than 50 wt % of the embodiments described herein. Alternatively, nanoparticles are included into the materials making up the devices at a wt % of less than 70 wt % of the embodiments described herein.

With the nanoparticles having the sizes described herein, the materials in which they are incorporated remain transparent to the encountered light. For example, when the nanoparticles are used in optical recording media, the material in which they are incorporated remains transparent to the emitted light. Similarly, when the nanoparticles are used in ocular devices the material in which the nanoparticles are incorporated remains transparent to visible light.

In other embodiments, the size of the nanoparticles may be controlled so that when the nanoparticles are incorporated into a particular material, the material prevents predetermined wavelengths of light from passing. The inclusion of nanoparticles may render the material non-transmissive to the predetermined wavelengths of light. In certain embodiments the nanoparticles can be used to block UV light from passing through the material while at the same time allowing visible light to pass through the material.

In some embodiments, the nanoparticles are not in physical contact with each other in a host material and are prevented from agglomerating. Agglomeration is understood to be when two or more nanoparticles come into physical contact. When any of the nanoparticles are in physical contact with another nanoparticle, the two nanoparticles essentially become one nanoparticle having a size of the combined two nanoparticles.

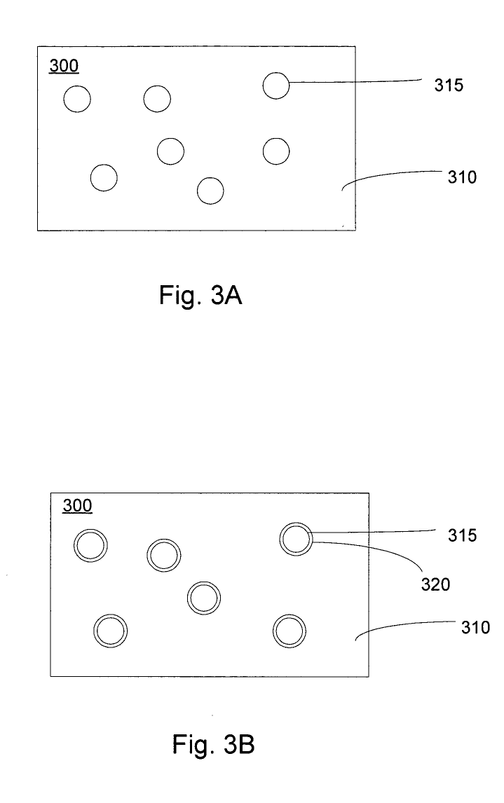

In certain embodiments, the nanoparticles are separated from each other by the host material. For example, FIG. 3A shows an exemplary section 300 of a host material 310. Host material 310 will be described below. As seen in FIG. 3A, host material 310 includes a plurality of nanoparticles 315. In the exemplary section 300, nanoparticles 315 are separated by host material 310.

In other embodiments, the nanoparticles are prevented from agglomerating by coating the nanoparticles with a coating. As shown in FIG. 3B, there is an exemplary section 300 of host material 310. As seen in FIG. 3B the host material 310 includes a plurality of nanoparticles 315 coated with a coating 320. The coating prevents the nanoparticles from agglomerating or flocking together. In an embodiment, the anti-agglomeration coating is a surfactant organic coating. Alternatively, the anti-agglomerant may be any other known organic coating with anti-agglomurent properties.

The nanoparticles listed herein have a refractive index greater than that of the substrate material. Thus, when nanoparticles are combined with the substrate material to form the substrate, the refractive index of the substrate is greater than that of the substrate material without the nanoparticles. Further, because the nanoparticles are prevented from agglomerating, they do no interfere with light as it passes through the substrate. In this manner, the light can be focused to a greater degree on recording layer 110. This permits pits 130 to be smaller and/or to be spaced closer together, thereby allowing for a greater information density.

Similarly, the nanoparticles listed herein have a scratch resistance greater than that of the protective material. Thus, when the nanoparticles are combined with the protective material the scratch resistance of the combination is greater than that of the protective material without the nanoparticles. Again, because the nanoparticles are prevented from agglomerating they do no interfere with the transparency of the protective material.

In certain embodiments, the nanoparticles are included in a polymer matrix that is disposed on the substrate material or the protective material. In these embodiments, the benefits of controlled refractive index and increased scratch resistance can be achieved without the substrate material or the protective material including nanoparticles.

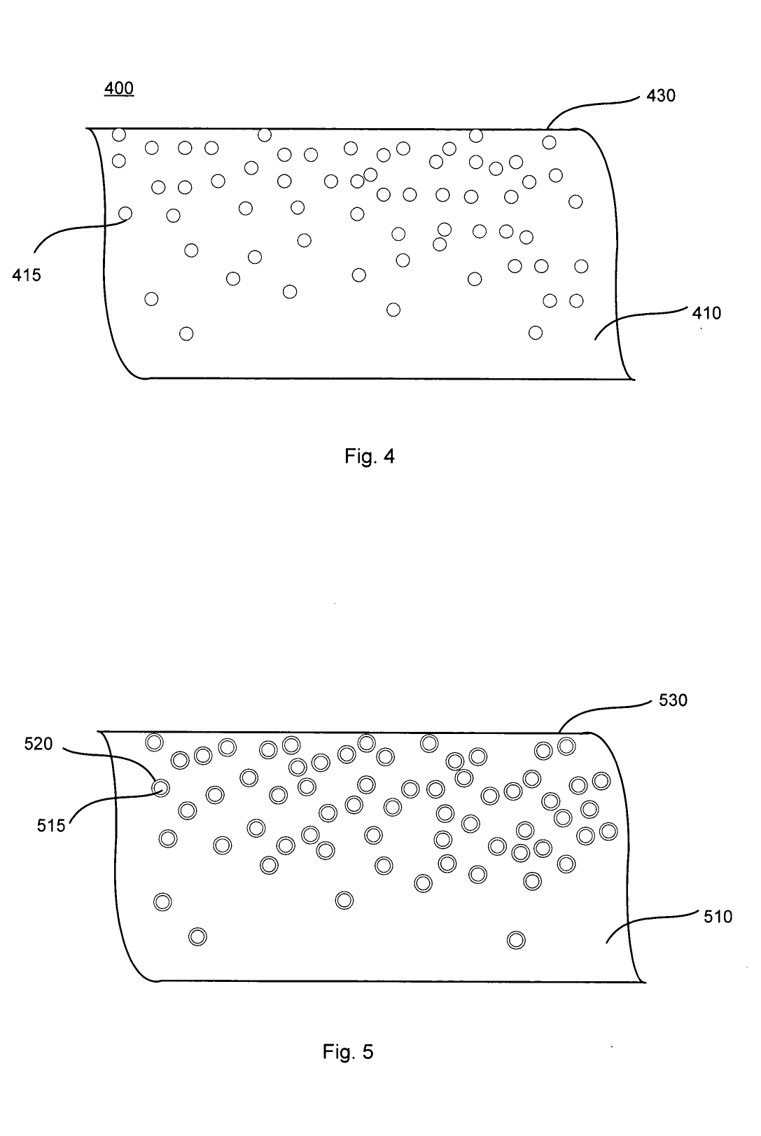

In another embodiment, shown in FIG. 4, a portion of a lens of an ocular device 400 includes nanoparticles 415 dispersed throughout a matrix 410 to provide scratch resistance to surface 430 of the ocular device. The ocular device may be eye glasses or any type of eyewear, such as, for, example, prescription glasses, sunglasses, goggles, non-prescription glasses, helmet visors or any other ocular device used to enhance vision, alter vision, or protect eyes.

Matrix 410 can be formed from any of the conventional materials used in the construction of reading glasses, prescription glasses, protective eyewear or sunglasses. These materials include, but are not limited to, transparent materials such as polycarbonates, polyolefins, polyurethanes, special-purpose plastics, such as, e.g., CR 39, and glass. Examples of these materials include CR 39, a copolymer made of diethyleneglycol and bisallylcarbonate.

The composition, size, and shape of nanoparticles 415 can vary as disclosed herein. Nanoparticles 415 may be dispersed uniformly or non-uniformly in the matrix. For example, nanoparticles 415 may be primarily dispersed near surface 430 to provide scratch resistance.

In certain embodiments, nanoparticles 415 are separated from each other by matrix 410. In other embodiments, as shown in FIG. 5, matrix 510 includes a plurality of nanoparticles 515 coated with a coating 520. The coating prevents the nanoparticles from agglomerating.

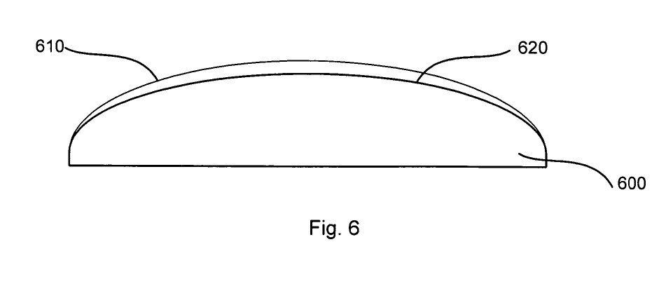

In another embodiment, a lens 600 for an ocular device shown in cross-section in FIG. 6, includes a coating 610 disposed on a surface 620 of lens 600. Coating 610 comprises nanoparticles (not shown) dispersed within a matrix material. The matrix material may be any coating applied to lenses or ocular devices, such as, for example, eyeglasses, including, but not limited to scratch resistant coatings, UV coatings, mirror coatings, and anti-reflection coatings. The nanoparticles may be any of the nanoparticles disclosed herein, or mixtures of those nanoparticles. The nanoparticles may be coated or uncoated.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An optical recording medium comprising:
a substrate including a substrate material having a refractive index and a plurality of nanoparticles of a material having a refractive index greater than that of the substrate material and being included in the substrate material at such a density that the refractive index of the substrate is greater than that of the substrate material without decreasing the transparency of the substrate;
a recording layer; and
a protective layer.

2. An optical recording medium according to claim 1, wherein the material that forms the nanoparticles is at least one of an oxide, a nitride, a carbide, a sulfide, a selenide, a metallic element, and a non-metallic element.

3. An optical recording medium according to claim 1, wherein the material that forms the nanoparticles is at least one of titanium dioxide (TiO₂), magnesium oxide (MgO), yttria (YtO), zirconia (ZrO₂), silicon oxide (SiOₓ), CeOₓ, alumina (Al₂O₃), lead oxide (PbOₓ), carbon nanotubes, a composite of yttria and zirconia, gallium nitride (GaN), silicon nitride, aluminum nitride, zinc selenide (ZnSe), zinc sulfide (ZnS), an alloy comprising Zn, Se, S, and Te (Tellurium).

4. An optical recording medium according to claim 1, wherein the refractive index of the substrate is greater than 1.55.

5. An optical recording medium according to claim 1, wherein the substrate material comprises one of plastic, epoxy, polycarbonate, polymethylmethacrylate (PMMA), and glass.

6. An optical recording medium according to claim 1, wherein the nanoparticles have a diameter of less than 1,000 nm.

7. An optical recording medium according to claim 1, wherein the nanoparticles have a diameter of less than 500 nm.

8. An optical recording medium according to claim 1, wherein the nanoparticles have a diameter of less than 100 nm.

9. An optical recording medium according to claim 1, wherein the nanoparticles have a diameter of less than 50 nm.

10. An optical recording medium according to claim 1, wherein the nanoparticles have a diameter of less than 20 nm.

11. An optical recording medium according to claim 1, wherein a wt % of the nanoparticles in the substrate is less than 50 wt %.

12. An optical recording medium according to claim 1, wherein laser light incident upon the substrate is focused to a spot size of less than about 1.7 μm.

13. An optical recording medium according to claim 1 further comprising a second substrate including a second substrate material having a refractive index and a second recording layer.

14. An optical recording medium according to claim 13 wherein the second substrate further comprises a plurality of nanoparticles of a material having a refractive index greater than that of the second substrate material and being included in the second substrate material at such a density that the refractive index of the second substrate is greater than that of the second substrate material without decreasing the transparency of the second substrate.

15. An optical recording medium according to claim 13, wherein the index of refraction of the substrate is different than the refractive index of the second substrate.

16. An optical recording medium comprising:
a substrate including a substrate material having a refractive index and a plurality of nanoparticles of a material having a refractive index greater than that of the substrate material and being included in the substrate material at such a density that the refractive index of the substrate is greater than that of the substrate material without decreasing the transparency of the substrate;
a recording layer having encoded information; and
a protective layer.

17. An optical recording medium according to claim 16 wherein the encoded information is stored as a series of pits.

18. An optical recording medium according to claim 17, wherein the material that forms the nanoparticles is at least one of an oxide, a nitride, a carbide, a sulfide, a selenide, a metallic element, and a non-metallic element.

19. An optical recording medium according to claim 17, wherein the material that forms the nanoparticles is at least one of titanium dioxide (TiO₂), magnesium oxide (MgO), yttria (YtO), zirconia (ZrO₂), silicon oxide (SiOₓ), CeOₓ, alumina (Al₂O₃), lead oxide (PbOₓ), carbon nanotubes, a composite of yttria and zirconia, gallium nitride (GaN), silicon nitride, aluminum nitride, zinc selenide (ZnSe), zinc sulfide (ZnS), an alloy comprising Zn, Se, S, and Te (Tellurium).

20. An optical recording medium comprising:
a substrate;
a recording layer; and
a protective layer including a protective material having a scratch resistance and a plurality of nanoparticles of a material having a scratch resistance greater than that of the protective material and being included in the protective material at such a density that the scratch resistance of the protective layer is greater than that of the protective material.

21. An optical recording medium according to claim 20, wherein the material that forms the nanoparticles is at least on of an oxide, a nitride, a sulfide, and a selenide.

22. An optical recording medium according to claim 20, wherein the material that forms the nanoparticles is at least one of titanium dioxide (TiO₂), magnesium oxide (MgO), yttria (YtO), zirconia (ZrO₂), silicon oxide (SiOₓ), silica, CeOₓ, alumina (Al₂O₃), lead oxide (PbOₓ), carbon nanotubes, a composite of yttria and zirconia, gallium nitride (GaN), silicon nitride, aluminum nitride, zinc selenide (ZnSe), zinc sulfide (ZnS), and an alloy comprising Zn, Se, S, Te (Tellurium).

23. An optical recording medium according to claim 20, wherein a wt % of the nanoparticles in the protective layer is less than 70 wt %.

24. An optical recording medium according to claim 20 wherein the recording layer includes encoded information.

25. An optical recording medium according to claim 24 wherein the encoded information is stored as a series of pits.

26. An ocular device with a scratch resistant surface comprising:
a matrix material having a surface;
nanoparticles dispersed within the matrix material to provide scratch resistance to the surface of the matrix material.

27. The ocular device according to claim 26, wherein the material that forms the nanoparticles is at least one of an oxide, a nitride, a sulfide, a carbide, and a selenide.

28. The ocular device according to claim 26, wherein the material that forms the nanoparticles is at least one of titanium dioxide (TiO₂), magnesium oxide (MgO), yttria (YtO), zirconia (ZrO₂), silicon oxide (SiOₓ), CeOₓ, alumina (Al₂O₃), lead oxide (PbOₓ), carbon nanotubes, a composite of yttria and zirconia, gallium nitride (GaN), silicon nitride, aluminum nitride, zinc selenide (ZnSe), zinc sulfide (ZnS), and an alloy comprising Zn, Se, S, and Te (Tellurium).

29. The ocular device according to claim 26, wherein the matrix material is at least one of a plastic and a glass.

30. The ocular device according to claim 26, wherein the matrix material is at least one of a polycarbonate, a polyolefin, a polyurethane, and CR 39.

31. A method of storing data comprising:
providing an optical storage medium comprising a substrate, a recording layer, and a protective layer; and
using a light source to record information onto the recording layer,
wherein the substrate comprises a substrate material having a refractive index and a plurality of nanoparticles having a refractive index greater than that of the substrate material and being included in the substrate material at such a density that the refractive index of the substrate is greater than that of the substrate material without decreasing the transparency of the substrate.

32. A method of claim 31, wherein the information comprises audio data.

33. A method of claim 31, wherein the information comprises text data.

34. A method of claim 31, wherein the information comprises audio data and video data.

35. The method of claim 32, wherein the light source is selected from a laser and a LED.

36. A coating for an ocular device comprising:
a matrix material; and
nanoparticles dispersed within the matrix material to provide scratch resistance to the surface of the matrix material.

37. The coating of claim 36, wherein the matrix material is at least one of a material forming a scratch resistant coating, a UV coating, a mirror coating, and an anti-reflection coating.

38. The coating of claim 36, wherein the nanoparticles comprise at least one of titanium dioxide (TiO₂), magnesium oxide (MgO), yttria (YtO), zirconia (ZrO₂), silicon oxide (SiOₓ), CeOₓ, alumina (Al₂O₃), lead oxide (PbOₓ), carbon nanotubes, a composite of yttria and zirconia, gallium nitride (GaN), silicon nitride, aluminum nitride, zinc selenide (ZnSe), zinc sulfide (ZnS), and an alloy comprising Zn, Se, S, and Te (Tellurium).

39. A method for coating an ocular device comprising:
providing a matrix material;
dispersing nanoparticles within the matrix material; and
applying the matrix material with the dispersed nanoparticles therein on a surface of the ocular device.

40. A method of claim 39, wherein the nanoparticles comprise at least one of an oxide, a nitride, a sulfide, a carbide, and a selenide.

41. A method of claim 39, wherein the nanoparticles comprise at least one of titanium dioxide (TiO₂), magnesium oxide (MgO), yttria (YtO), zirconia (ZrO₂), silicon oxide (SiOₓ), CeOₓ, alumina (Al₂O₃), lead oxide (PbOₓ), carbon nanotubes, a composite of yttria and zirconia, gallium nitride (GaN), silicon nitride, aluminum nitride, zinc selenide (ZnSe), zinc sulfide (ZnS), and an alloy comprising Zn, Se, S, and Te (Tellurium).

42. A method of claim 39, wherein the matrix material and the dispersed nanoparticles form at least one of a scratch resistant coating, a UV coating, a mirror coating, and an anti-reflection coating.

43. An ocular device comprising:
a first matrix material; and
a coating comprising a second matrix material and a plurality of nanoparticles.

44. An ocular device of claim 43, wherein the first matrix material is at least one of a plastic and a glass.

45. The ocular device of claim 43, wherein the first matrix material is at least one a polycarbonate, a polyolefin, a polyurethane, and CR 39.

46. The ocular device of claim 43, wherein the second matrix material forms at least on of a scratch resistant coating, a UV coating, a mirror coating, and an anti-reflection coating

47. The ocular device of claim 43, wherein the nanoparticles comprise at least one of an oxide, a nitride, a sulfide, a carbide, and a selenide.

48. The ocular device of claim 43, wherein the nanoparticles comprise at least one of titanium dioxide (TiO₂), magnesium oxide (MgO), yttria (YtO), zirconia (ZrO₂), silicon oxide (SiOₓ), CeOₓ, alumina (Al₂O₃), lead oxide (PbOₓ), carbon nanotubes, a composite of yttria and zirconia, gallium nitride (GaN), silicon nitride, aluminum nitride, zinc selenide (ZnSe), zinc sulfide (ZnS), and an alloy comprising Zn, Se, S, and Te (Tellurium).

49. The ocular device of claim 43, wherein the nanoparticles are coated to prevent agglomeration.
